(19) United States
(12) Patent Application Publication
(10) Pub. No.: US 2013/0102739 A1
(43) Pub. Date: Apr. 25, 2013

(54) METHOD FOR IMPARTING HYDROPHILICITY TO SILICONE RUBBER

(71) Applicant: SHIN-ETSU CHEMICAL CO., LTD., Tokyo (JP)

(72) Inventors: Takashi AKETA, Annaka-shi (JP); Toshio YAMAZAKI, Annaka-shi (JP); Atsushi YAGINUMA, Annaka-shi (JP)

(73) Assignee: SHIN-ETSU CHEMICAL CO., LTD., Tokyo (JP)

(21) Appl. No.: 13/656,063

(22) Filed: Oct. 19, 2012

(30) Foreign Application Priority Data
Oct. 20, 2011 (JP) 2011-230529

(51) Int. Cl. C08G 77/38

(52) U.S. Cl. 525/474

(57) ABSTRACT

A silicone rubber which is formed by curing an addition-curable silicone rubber composition comprising a branched organohydrogenpolysiloxane is hydrophilized by subjecting the surface of the silicone rubber to plasma polymerization in the presence of a gas mixture containing methane and oxygen. The method readily imparts hydrophilicity to the silicone rubber surface and the hydrophilic surface is maintained for a long period.

### CROSS-REFERENCE TO RELATED APPLICATION

This non-provisional application claims priority under 35 U.S.C. 5119(a) on Patent Application No. 2011-230529 filed in Japan on Oct. 20, 2011, the entire contents of which are hereby incorporated by reference.

### TECHNICAL FIELD

This invention relates a method for imparting hydrophilicity to the surface of cured silicone rubber.

### BACKGROUND ART

Generally, silicone rubber is hydrophobic on surface. In certain applications, silicone rubber having a hydrophilic surface is required. It is especially desired to render the surface of cured product (or silicone rubber) of an addition-curable silicone rubber composition hydrophilic in a simple manner and for a long period.

### CITATION LIST

Patent Document 1: JP-A S56-000831 (USP 4344981)

Patent Document 2: JP-A S61-293226 (USP 4920184)

Patent Document 3: JP-A H06-219868

Patent Document 4: JP-A H08-227001

### DISCLOSURE OF INVENTION

An object of the invention is to provide a method for readily hydrophilizing the surface of cured product (or silicone rubber) of an addition-curable silicone rubber composition for a long period of time, and a silicone rubber which is hydrophilized thereby.

Typical prior art methods for hydrophilizing originally hydrophobic silicone rubber surfaces are treatments with oxygen plasma, argon plasma and the like, which maintain hydrophilicity for a short time and raise working problems. The inventors have found that plasma polymerization using a gas mixture containing methane and oxygen is an effective means for hydrophilizing silicone rubber. With this method, the contact angle gradually increases, in contrast to an abrupt increase of contact angle in the case of oxygen plasma treatment. It has been found that when applied to addition-cured silicone rubber which has been crosslinked using a branched organohydrogenpolysiloxane, specifically an organohydrogenpolysiloxane comprising RSiO_{3/2} units (wherein R is hydrogen or a substituted or unsubstituted monovalent hydrocarbon radical free of aliphatic unsaturation) and/or SiO₂ units and having at least two silicon-bonded hydrogen atoms (i.e., SiH radicals) in a molecule, this method can retard the increase of contact angle and maintain hydrophilicity for a long period of time.

In one aspect, the invention provides a method for imparting hydrophilicity to a silicone rubber which is formed by curing an addition-curable silicone rubber composition comprising an organohydrogenpolysiloxane having a branched structure. Hydrophilicity is imparted by subjecting at least a part of the surface of the silicone rubber to plasma polymerization in the presence of a gas mixture containing methane and oxygen.

In a preferred embodiment, the addition-curable silicone rubber composition comprises:

(A) 50 to 100 parts by weight of a diorganopolysiloxane having at least two alkenyl radicals in a molecule, represented by the formula (1):

Xₒ—SiRₚ¹O—(SiR₂¹O)ₙ—(SiR¹(X)O)ₘ—SiRₚ¹—Xₒ (1)

wherein R¹ is each independently a substituted or unsubstituted monovalent hydrocarbon radical free of aliphatic unsaturation, X is an alkenyl radical, o and p each are an integer of 0 to 3 and o+p is 3, m is 0 or an integer of at least 1, and n is 0 or an integer of at least 1, with the proviso that m is an integer of at least 2 when o is 0.

(B) 50 to 0 parts by weight of an organopolysiloxane resin comprising siloxane units of the formula: R₃²SiO_{1/2} wherein R² is each independently a monovalent hydrocarbon radical of 1 to 10 carbon atoms and siloxane units of the formula: SiO_{4/2} in a molecule, and having at least two alkenyl radicals in a molecule, provided that the total of components (A) and (B) is 100 parts by weight,

(C) an organohydrogenpolysiloxane comprising R₂³(H)SiO_{1/2} units and SiO_{4/2} units and optionally, R₃³SiO_{1/2} units, R₃²SiO_{2/2} units, R³(H)SiO_{2/2} units, (H) SiO_{3/2} units or R³SiO_{3/2} units, and having at least two silicon-bonded hydrogen atoms (i.e., SiH radicals) in a molecule wherein R³ is each independently a substituted or unsubstituted monovalent hydrocarbon radical free of aliphatic unsaturation, the organohydrogenpolysiloxane being present in such an amount that the ratio of SiH radicals to the total of alkenyl radicals in components (A) and (B) may be in a range of 0.3/1 to 10/1,

(D) a catalytic amount of a hydrosilylation reaction catalyst, and optionally,

(E) a cure inhibitor.

The gas mixture containing methane and oxygen is typically a mixture of methane and air or a mixture of methane and oxygen.

Also provided is a silicone rubber having a surface wherein hydrophilicity is imparted to at least a part of the silicone rubber surface by the method defined above.

### ADVANTAGEOUS EFFECTS OF INVENTION

The method of the invention readily imparts hydrophilicity to the surface of silicone rubber. The hydrophilic surface is long lasting.

### DESCRIPTION OF EMBODIMENTS

One embodiment of the invention is a method for imparting hydrophilicity to a silicone rubber which is formed by curing an addition-curable silicone rubber composition, the method comprising the step of subjecting the surface of the silicone rubber, in its entirety or in part, to plasma polymerization in the presence of a gas mixture containing methane and oxygen. In this embodiment, any addition-curable silicone rubber compositions may be used as long as they contain an organohydrogenpolysiloxane having a branched structure as a crosslinker and cure through hydrosilylation reaction. Preferably the composition comprises components (A) to (D), and optionally component (E) and other components to be described below.

(A) Alkenyl-containing diorganopolysiloxane

Component (A) is an organopolysiloxane which is a base component in the composition. The organopolysiloxane contains on average at least two alkenyl radicals in a molecule and has the following formula.

Xₒ—SiRₚ¹O—(SiR₂¹O)ₙ—(SiR¹(X)O)ₘ—SiRₚ¹—Xₒ (1)

Herein R¹ is each independently a substituted or unsubstituted monovalent hydrocarbon radical free of aliphatic unsaturation, X is an alkenyl radical, the subscripts o and p are each independently an integer of 0 to 3 and o+p is invariably 3, m is 0 or an integer of at least 1, and n is 0 or an integer of at least 1, with the proviso that m is an integer of at least 2 when o is 0.

Suitable alkenyl radicals in component (A) are those of 2 to 8 carbon atoms including vinyl, allyl, butenyl, pentenyl, hexenyl, and heptenyl, with vinyl being preferred. The alkenyl radicals may be attached to component (A) at ends and/or side chains of the molecular chain.

In addition to the alkenyl radicals, component (A) contains silicon-bonded organic radicals R¹. Organic radicals of 1 to 10 carbon atoms are preferred as R¹. Examples include alkyl radicals such as methyl, ethyl, propyl, butyl, pentyl, hexyl and heptyl; aryl radicals such as phenyl, tolyl, xylyl and naphthyl; aralkyl radicals such as benzyl and phenethyl; and haloalkyl radicals such as chloromethyl, 3-chloropropyl and 3,3,3-trifluoropropyl. Inter alia, methyl and phenyl are preferred.

Component (A) may be either liquid or gum-like. The sum of m+n is preferably 10 to 10,000, more preferably 100 to 2,000. Also preferably m/(m+n) is 0 to 0.2, more preferably 0 to 0.1. Since liquid is preferred from the aspect of working, component (A) preferably has a viscosity in the range of 100 to 500,000 mPa-s at 25° C., more preferably 300 to 100,000 mPa-s at 25° C. It is noted that the viscosity is measured by a rotational viscometer.

Examples of the organopolysiloxane as component (A) include trimethylsiloxy-endcapped dimethylsiloxane/methylvinylsiloxane copolymers, trimethylsiloxy-endcapped methylvinylpolysiloxane, trimethylsiloxy-endcapped dimethylsiloxane/methylvinylsiloxane/methylphenylsiloxane copolymers, dimethylvinylsiloxy-endcapped dimethylpolysiloxane, dimethylvinylsiloxy-endcapped methylvinylpolysiloxane, dimethylvinylsiloxy-endcapped dimethylsiloxane/methylvinylsiloxane copolymers, dimethylvinylsiloxy-endcapped dimethylsiloxane/methylvinylsiloxane/methylphenylsiloxane copolymers, and trivinylsiloxy-endcapped dimethyl polysiloxane. It is noted that the term “endcapped” means that a siloxane is capped at both ends of the molecular chain with the referenced radicals, unless otherwise stated.

(B) Alkenyl-containing organopolysiloxane resin

Component (B) is an organopolysiloxane resin comprising siloxane units of the formula: R₃²SiO_{1/2}, and siloxane units of the formula: SiO_{4/2} in a molecule and having at least two alkenyl radicals in a molecule. Herein R² is each independently a monovalent hydrocarbon radical of 1 to 10 carbon atoms. Suitable monovalent hydrocarbon radicals of R² include alkyl radicals such as methyl, ethyl and propyl, aryl radicals such as phenyl, and alkenyl radicals such as vinyl. Of these, methyl, phenyl and vinyl are preferred, with methyl and vinyl being most preferred.

The organopolysiloxane resin preferably contains R₃²SiO_{1/2} units and SiO_{4/2} units in a molar ratio (R₃²SiO_{1/2}/SiO_{4/2}) of 0.6/1 to 1.2/1. In addition to the foregoing R₃²SiO_{1/2} and SiO_{4/2} units, the organopolysiloxane resin may contain R²SiO_{3/2} units and/or R₂²SiO_{2/2} units in an amount of 50 mol % or less, especially 30 mol % or less of the resin.

Examples of the organopolysiloxane resin include resins consisting of (CH₃)₃SiO_{1/2} units, (CH₂═CH)(CH₃)₂SiO_{1/2} units and SiO_{4/2} units; resins consisting of (CH₂═CH)(CH₃)₂SiO_{1/2} units and SiO_{4/2} units; resins consisting of (CH₂═CH)(CH₃)₂SiO_{1/2} units, (CH₂═CH)SiO_{3/2} units and SiO_{4/2} units; resins consisting of (CH₂═CH)(CH₃)₂SiO_{1/2} units, (CH₃)SiO_{3/2} units and SiO_{4/2} units; and resins consisting of (CH₂═CH)(CH₃)₂SiO_{1/2} units, (CH₃)₂/₂ units and SiO_{4/2} units. Component (B) may be either solid or liquid. When solid component (B) is selected, it is preferably dissolved in component (A) prior to use.

Components (A) and (B) are preferably combined in a proportion of 50 to 100 parts by weight of component (A) and 50 to 0 parts by weight of component (B), more preferably 70 to 100 parts by weight of component (A) and 30 to 0 parts by weight of component (B), provided that the total of components (A) and (B) is 100 parts by weight. Component (B) is advantageously compounded when the silicone rubber is required to have a high hardness or strength. Too much amounts of component (B) may detract from rubber elasticity.

### (C) Organohydrogenpolysiloxane

The key is use of an organohydrogenpolysiloxane having a branched structure as a crosslinker. The branched organohydrogenpolysiloxane is not particularly limited as long as it comprises RSiO_{3/2} units wherein R is hydrogen or a radical like R¹, and/or SiO_{4/2} units in a molecule and has at least two silicon-bonded hydrogen atoms (i.e., SiH radicals) in a molecule.

The preferred organohydrogenpolysiloxane as component (C) is an organohydrogenpolysiloxane resin comprising R₂³(H)SiO_{1/2} units and SiO_{4/2} units, and optionally R₂³SiO_{1/2} units, R₂³SiO_{2/2} units, R³(H)SiO_{2/2} units, (H)SiO_{3/2} units or R³SiO_{3/2} units. Herein R³ is a substituted or unsubstituted monovalent hydrocarbon radical as exemplified for R¹. Specifically, the number of R₂³(H)SiO_{1/2} units per SiO_{4/2} unit is preferably in a range of 1.2 to 2.5. The number of SiO_{4/2} units is not particularly limited as long as at least one SiO_{4/2} unit is contained per molecule. The organohydrogenpolysiloxane having branched structure may be either liquid or solid, and is preferably liquid at room temperature for handling. It preferably has a viscosity of 1 to 1,000 mm²/s, more preferably 5 to 500 mm²/s, and most preferably 10 to 200 mm²/s, as measured by an Ostwald viscometer.

Component (C) is compounded in such an amount that the ratio of silicon-bonded hydrogen atoms (or SiH radicals) to the total of alkenyl radicals in components (A) and (B) may be in a range of 0.3/1 to 10/1, preferably 0.5 to 5.

### (D) Platinum Group Metal Catalyst

The platinum group metal catalyst promotes addition reaction (i.e., hydrosilylation) of alkenyl radicals in components (A) and (B) with silicon-bonded hydrogen atoms in component (C). The catalyst may be any of well-known platinum, rhodium and palladium based catalysts for use in hydrosilylation reaction. Examples of the catalyst include platinum group metals alone such as platinum (including platinum black), rhodium and palladium; platinum chlorides, chloroplatinic acid and chloroplatinic acid salts such as H₂PtCl₄.nH₂O, H₂PtCl₆.nH₂O, NaHPtCl₆.nH₂O, KHPtCl₆.nH₂O, Na₂PtCl₆.nH₂O, K₂PtCl₄.nH₂O, PtCl₄.nH₂O, PtCl₂ and Na₂HPtCl₄.nH₂O, wherein n is an integer of 0 to 6, preferably 0 or 6;

alcohol-modified chloroplatinic acids (see U.S. Pat. No. 3,220,972); chloroplatinic acid-olefin complexes (see U.S. Pat. No. 3,159,601, U.S. Pat. No. 3,159,662, U.S. Pat. No. 3,775,452); supported catalysts comprising platinum group metals such as platinum black and palladium on supports of alumina, silica and carbon; rhodium-olefin complexes; chlorotris(triphenylphosphine)rhodium (known as Wilkinson's catalyst); and complexes of platinum chlorides, chloroplatinic acid and chloroplatinic acid salts with vinyl-containing siloxanes, specifically vinyl-containing cyclosiloxanes.

Component (D) may be used in a catalytic amount, which is specifically about 0.1 to about 1,000 ppm, more specifically about 0.5 to about 500 ppm of platinum group metal based on the total weight of components (A) and (B).

### (E) Cure Inhibitor

To the addition-curable silicone rubber composition used herein, (E) a cure inhibitor may be added in order to enhance the workability. The cure inhibitor is not particularly limited as long as it can inhibit the composition from curing under conditions other than the desired curing conditions. Examples of the cure inhibitor include acetylene alcohol compounds, triallyl isocyanurate compounds, low molecular weight vinyl-containing polysiloxanes, alkyl maleates, hydroperoxides, tetramethylethylenediamine, benzotriazole and mixtures of the foregoing.

The cure inhibitor may be compounded in an amount capable of providing a necessary working life, which is specifically 0.0001 to 5 parts, more specifically 0.01 to 2 parts by weight per 100 parts by weight of components (A) and (B) combined.

While other components may be compounded, fine powder silica having reinforcing effect is preferred. The fine powder silica functions to enhance the mechanical strength of the cure product and may be any of well-known silica species used in prior art silicone rubber. Examples include fumed silica, precipitated silica, pyrogenic silica, quartz powder, and diatomaceous earth. The silica may be used alone or in admixture of two or more. The silica particles generally have a specific surface area of at least 50 m²/g, specifically about 50 to about 500 m²/g as measured by the BET method. While fine powder silica may be used as such, the silica is preferably treated, prior to use, with organosilicon compounds such as methylchlorosilanes, dimethylpolysiloxane and hexamethyldisilazane for imparting good fluidity to the composition.

In addition to the above components (A) to (E), reinforcing inorganic fillers such as fumed titanium dioxide and non-reinforcing inorganic fillers such as calcium silicate, titanium dioxide, ferric oxide and carbon black may be added to the composition, if necessary. These inorganic fillers are used in an amount of 0 to 200 parts by weight per 100 parts by weight of the total of the components excluding the inorganic filler. Further, well-known additive such as heat resistance enhancers, parting agents, and mildew-proofing and anti-fungus agents may be added to the composition.

The addition-curable silicone rubber composition may be molded by any conventional molding methods and cured, typically by heat. Even when the addition-curable silicone rubber composition will cure at room temperature, the method for imparting hydrophilicity is effectively applicable thereto.

According to the invention, hydrophilicity is imparted to the surface of the resulting silicone rubber by subjecting the silicone rubber surface to plasma polymerization in the presence of a gas mixture containing methane and oxygen. Specifically, the gas mixture containing methane and oxygen may be a mixture of methane and air or a mixture of methane and oxygen. Air may be preferably mixed with methane in an amount of 0.01 to 5 parts by volume, more preferably 0.05 to 3 parts by volume, and even more preferably 0.1 to 2 parts by volume per part by volume of methane. When oxygen is mixed with methane, oxygen may be preferably used in an amount of 0.01 to 3 parts by volume, more preferably 0.05 to 2 parts by volume, and even more preferably 0.1 to 1.5 parts by volume per part by volume of methane. Too high or too low a ratio of oxygen to methane may lead to insufficient hydrophilicity.

Plasma polymerization conditions may be selected from a wide range as long as sufficient hydrophilicity is imparted. The gas mixture is preferably under a pressure of about 0.01 to 50 Pa, more preferably about 0.1 to 10 Pa. The treatment time is preferably about 10 seconds to 1 hour, more preferably about 1 minute to 20 minutes. The power is preferably about 1 to 500 W, more preferably about 20 to 80 W. Any commercially available plasma polymerization system may be used.

### Example

Examples of the invention are given below by way of illustration and not by way of limitation while components for silicone elastomers are described below.

Plasma polymerization was carried out using a plasma polymerization system available from Shinko Seiki Co., Ltd. Silicone elastomer was plasma treated by placing it in a bell jar (reaction chamber, volume 105 L), vacuum pumping the bell jar to a pressure of about 0.1 Pa, and holding the pressure for 10 minutes. A reactive gas or a gas mixture of methane and oxygen was continuously fed while it was withdrawn by a vacuum pump so that the preselected pressure was established.

In Examples, the viscosity of component (A) was measured by a rotational viscometer and the viscosity of component (C) and corresponding components was measured by an Ostwald viscometer.

### Examples and Comparative Examples

Addition-curable silicone rubber compositions were prepared using the following components.

(A) Diorganopolysiloxane having at least two alkenyl radicals per molecule

A vinyl-containing linear organopolysiloxane of the formula: Vi(Me)₂Si—(OSiMe₂)ₙ—OSi(Me)₂Vi wherein Me is methyl, Vi is vinyl, and n is such a number that the siloxane may have a viscosity of 5,000 mPa-s at 25° C.

(B) Alkenyl-containing organopolysiloxane resin

A solid resin consisting of (CH₃)₃SiO_{1/2} units, (CH₂═CH)(CH₃)₂SiO_{1/2} units and SiO_{4/2} units in a molar ratio of 7:1:10 and having a vinyl content of 0.085 mole/100 g of the resin

### (C) Organohydrogenpolysiloxane

(C-1) An organohydrogenpolysiloxane containing 1.5 (CH₃)₂(H)SiO_{1/2} units (M^{H}) per SiO_{4/2} unit (Q), that is, M_{4.5}^{H}Q₃ in the structure (viscosity: 35 mm²/g)
(C-2) An organohydrogenpolysiloxane containing 1.2 (CH₃)₂(H)SiO_{1/2} units per SiO_{4/2} unit, that is, M_{4.8}^{H}Q₄ in the structure (viscosity: 60 mm²/g)
(C-3) An organohydrogenpolysiloxane containing 1.8 (CH₃)₂(H)SiO_{1/2} units per SiO_{4/2} unit, that is, M₆^{H}Q_{3.3} in the structure (viscosity: 40 mm²/g)
(C′) Organohydrogenpolysiloxane having at least two silicon-bonded hydrogen atoms per molecule and free of branched structure

### (C′-1) M-D₂₅^{H}-D₇₅-M

### (C′-2) M-D₁₈-D₂₀^{H}-M

M, D^{H} and D stand for the following units.

M: (CH₃)₃SiO_{1/2}

D^{H}: (CH₃)(H)SiO_{2/2}

D: (CH₃)₂SiO_{2/2}

### (D) Hydrosilylation Reaction Catalyst

Platinum-divinyltetramethyldisiloxane complex in toluene (platinum content 0.5 wt %)

### (E) Cure Inhibitor

1,3,5,7-tetramethyltetravinylcyclosiloxane

### Experiment

A silicone rubber composition was prepared by combining components (A), (B) and (D), mixing them, adding component (E) and mixing, and finally adding component (C) and mixing. The mixture was transferred to a vacuum degassing apparatus where it was thoroughly degassed. It was then press molded at 150° C. for 30 minutes into a silicone rubber of 1 mm thick.

The resulting silicone rubber was plasma treated. Two sets of plasma treatment conditions were used.

Set 1: combination of methane and air

Treatment pressure 4 Pa

Gas mixture of 2 ml/min methane and 1 ml/min air fed

into the bell jar

Frequency 15 kHz

Power consumption 32 W

Set 2: combination of methane and oxygen

Treatment pressure 4 Pa

Gas mixture of 2 ml/min methane and 0.51 ml/min oxygen

fed into the bell jar

Frequency 15 kHz

Power consumption 32 W

The thus treated silicone elastomer was determined for a contact angle at the surface according to the θ/2 method using a contact angle meter DM-701 (Kyowa Interface Science Co., Ltd.). The liquid used was deionized water. Each sample was measured at three points of time, 30 minutes after the plasma treatment, after one week and one month of storage in air.

TABLE 1

| Amount | Example | | | | | | Comparative Example | | | |
|---|---|---|---|---|---|---|---|---|---|---|
| (pbw) | 1 | 2 | 3 | 4 | 5 | 6 | 1 | 2 | 3 | 4 |
| Plasma treatment | | | | | | | | | | |
| condition | Set 1 | Set 1 | Set 1 | Set 2 | Set 2 | Set 2 | Set 1 | Set 1 | Set 2 | Set 2 |
| A | 80 | 80 | 80 | 80 | 80 | 80 | 80 | 80 | 80 | 80 |
| B | 20 | 20 | 20 | 20 | 20 | 20 | 20 | 20 | 20 | 20 |
| C-1 | 5 | | | 5 | | | | | | |
| C-2 | | 5 | | | 5 | | | | | |
| C-3 | | | 5 | | | 5 | | | | |
| C′-1 | | | | | | | 9.2 | 9.2 | | |
| C′-2 | | | | | | | | | 4.8 | 4.8 |
| D | 0.15 | 0.15 | 0.15 | 0.15 | 0.15 | 0.15 | 0.15 | 0.15 | 0.15 | 0.15 |
| E | 0.2 | 0.2 | 0.2 | 0.2 | 0.2 | 0.2 | 0.2 | 0.2 | 0.2 | 0.2 |

Measurement results

| | | | | | | | | | | |
|---|---|---|---|---|---|---|---|---|---|---|
| Contact angle | 48 | 49 | 48 | 56 | 54 | 56 | 58 | 56 | 60 | 59 |
| after 30 min, ° | | | | | | | | | | |
| Contact angle | 65 | 66 | 66 | 70 | 68 | 72 | 75 | 78 | 80 | 79 |
| after 1 week, ° | | | | | | | | | | |
| Contact angle | 75 | 74 | 73 | 75 | 75 | 73 | 90 | 89 | 88 | 90 |
| after 1 month, ° | | | | | | | | | | |

*pbw: parts by weight

Japanese Patent Application No. 2011-230529 is incorporated herein by reference.

Although some preferred embodiments have been described, many modifications and variations may be made thereto in light of the above teachings. It is therefore to be understood that the invention may be practiced otherwise than as specifically described without departing from the scope of the appended claims.

1. A method for imparting hydrophilicity to a silicone rubber which is formed by curing an addition-curable silicone rubber composition comprising an organohydrogenpolysiloxane having a branched structure,
the method comprising subjecting at least a part of the surface of the silicone rubber to plasma polymerization in the presence of a gas mixture containing methane and oxygen.

2. The method of claim 1, wherein the addition-curable silicone rubber composition comprises:
(A) 50 to 100 parts by weight of a diorganopolysiloxane having at least two alkenyl radicals in a molecule, represented by the formula (1):
Xₒ—SiRₚ¹O—(SiR₂¹O)ₙ—(SiR¹(X)O)ₘ—SiRₚ¹—Xₒ (1)
wherein R¹ is each independently a substituted or unsubstituted monovalent hydrocarbon radical free of aliphatic unsaturation, X is an alkenyl radical, o and p each are an integer of 0 to 3 and o+p is 3, m is 0 or an integer of at least 1, and n is 0 or an integer of at least 1, with the proviso that m is an integer of at least 2 when o is 0.
(B) 50 to 0 parts by weight of an organopolysiloxane resin comprising siloxane units of the formula: R₃²SiO_{1/2} wherein R² is each independently a monovalent hydrocarbon radical of 1 to 10 carbon atoms and siloxane units of the formula: SiO_{4/2} in a molecule, and having at least two alkenyl radicals in a molecule, provided that the total of components (A) and (B) is 100 parts by weight,
(C) an organohydrogenpolysiloxane comprising R₂³(H)SiO_{1/2} units and SiO_{4/2} units and optionally, R₃³SiO_{1/2} units, R₂³SiO_{2/2} units, R³(H)SiO_{2/2} units, (H)SiO_{3/2} units or R³SiO_{3/2} units, and having at least two silicon-bonded hydrogen atoms in a molecule wherein R³ is each independently a substituted or unsubstituted monovalent hydrocarbon radical free of aliphatic unsaturation, the organohydrogenpolysiloxane being present in such an amount that the ratio of silicon-bonded hydrogen atoms to the total of alkenyl radicals in components (A) and (B) may be in a range of 0.3/1 to 10/1, and
(D) a catalytic amount of a hydrosilylation reaction catalyst.

3. The method of claim 2, wherein the addition-curable silicone rubber composition further comprises (E) a cure inhibitor.

4. The method of claim 1, wherein the gas mixture containing methane and oxygen is a mixture of methane and air or a mixture of methane and oxygen.

5. A silicone rubber having a surface wherein hydrophilicity is imparted to at least a part of the silicone rubber surface by the method of any one of claims 1 to 4.
